(19) United States
(12) Patent Application Publication
(10) Pub. No.: US 2026/0125079 A1
(43) Pub. Date: May 7, 2026

(54) INTEGRATING HUMAN AND AI PREFERENCES IN AUTONOMOUS VEHICLES

(71) Applicant: Texas State University, San Marcos, TX (US)

(72) Inventors: Heena Rathore, San Marcos, TX (US); Henry Griffith, San Antonio, TX (US)

(21) Appl. No.: 19/381,038

(22) Filed: Nov. 6, 2025

Related U.S. Application Data
(60) Provisional application No. 63/716,865, filed on Nov. 6, 2024.

(51) Int. Cl. B60W 60/00; G06N 20/00

(52) U.S. Cl. CPC B60W 60/0011; G06N 20/00

(57) ABSTRACT

A computer-implemented method, system, and computer program product for autonomous vehicle ethical decision-making. A dataset of human moral judgements regarding autonomous vehicle ethical dilemmas is obtained, such as via a moral machine framework. Furthermore, a reinforcement learning (RL) agent is trained using the dataset to determine a preferred ethical action in a given dilemma. As a result of such training, the trained RL agent is responsible for synthesizing the human-preferred choices from the dataset into a functional policy. The preferred ethical action in a given action that was determined by the trained RL agent is then executed to control the autonomous vehicle (AV). For example, the RL agent's ethically-informed decisions directly govern the AV's behavior, such as steering or braking. Such an execution of the preferred ethical action translates the theoretical moral policy trained on human preferences into an on-the-road control command that influences the vehicle's operation in real-time.

### TECHNICAL FIELD

The present disclosure relates generally to autonomous vehicles, and more particularly to integrating human and artificial intelligence (AI) preferences in autonomous vehicles.

### BACKGROUND

Autonomous vehicles (AVs), also known as driverless or self-driving cars, are vehicles that can operate with little or no human input. They use sensors, cameras, and complex software to perceive their environment, make driving decisions, and perform actions, such as steering, accelerating, and braking. This technology can be applied to a wide range of vehicles, from cars and shuttles to trucks and buses.

The rapid advancement of autonomous vehicles presents a critical challenge in ensuring their ethical decision-making capabilities, particularly in scenarios involving moral uncertainty and high stakes. Current approaches to AV decision-making primarily rely on established ethical frameworks, such as utilitarianism (maximizing overall well-being) or deontology (adherence to rules and duties).

However, these rule-based systems often struggle with nuanced human ethical preferences and lack the adaptability to handle morally complex situations that may involve demographic-based decision biases (e.g., differences based on age or gender). This limitation poses a significant hurdle to societal acceptance and trustworthiness of AV technology as the public expects transparent and ethically aligned decision-making.

### SUMMARY

In one embodiment of the present disclosure, a computer-implemented method for autonomous vehicle ethical decision-making comprises obtaining a dataset of human moral judgements regarding autonomous vehicle ethical dilemmas, where the dataset is collected via a moral machine framework. The method further comprises training a reinforcement learning agent using the dataset to determine a preferred ethical action in a given dilemma. The method additionally comprises executing the preferred ethical action determined by the trained reinforcement learning agent to control an autonomous vehicle.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates the internal components of an autonomous vehicle in accordance with an embodiment of the present disclosure;

FIG. 2 is a diagram of the software components used by the autonomous driving compute system to enhance moral decision-making capabilities of autonomous vehicles in accordance with an embodiment of the present disclosure;

FIG. 3 is a flowchart of a method for enhancing more decision-making capabilities of autonomous vehicles in accordance with an embodiment of the present disclosure; and

FIG. 4 is a flowchart of a method for training the reinforcement learning (RL) agent to determine a preferred ethical action in a given dilemma in accordance with an embodiment of the present disclosure.

### DETAILED DESCRIPTION

As stated above, autonomous vehicles (AVs), also known as driverless or self-driving cars, are vehicles that can operate with little or no human input. They use sensors, cameras, and complex software to perceive their environment, make driving decisions, and perform actions, such as steering, accelerating, and braking. This technology can be applied to a wide range of vehicles, from cars and shuttles to trucks and buses.

The rapid advancement of autonomous vehicles presents a critical challenge in ensuring their ethical decision-making capabilities, particularly in scenarios involving moral uncertainty and high stakes. Current approaches to AV decision-making primarily rely on established ethical frameworks, such as utilitarianism (maximizing overall well-being) or deontology (adherence to rules and duties).

However, these rule-based systems often struggle with nuanced human ethical preferences and lack the adaptability to handle morally complex situations that may involve demographic-based decision biases (e.g., differences based on age or gender). This limitation poses a significant hurdle to societal acceptance and trustworthiness of AV technology as the public expects transparent and ethically aligned decision-making.

The embodiments of the present disclosure provide a means for providing a novel, integrated framework that addresses this gap by directly embedding human moral preferences into machine learning models for AV decision-making. Specifically, in one embodiment, data from the moral machine framework—a vast dataset of human moral judgments across diverse demographics—is utilized to train machine learning agents. This unique integration aims to produce AV decisions that more closely mirror societal moral standards thereby enhancing public trust and providing a clearer basis for regulatory and liability assessments. Furthermore, in one embodiment, the framework employs reinforcement learning (RL), utilizing mechanisms, such as Nash and variance voting, to balance competing ethical theories based on these human preferences, and also deploys large language models (LLMs) to simulate complex, demographic-aware moral reasoning, moving beyond fixed ethical principles to a more adaptive and human-aligned system. In this manner, moral decision-making capabilities of autonomous vehicles are enhanced. A further discussion regarding these and other features is provided below.

In some embodiments of the present disclosure, the present disclosure comprises a computer-implemented method, system, and computer program product for autonomous vehicle ethical decision-making. In one embodiment of the present disclosure, a dataset of human moral judgements regarding autonomous vehicle ethical dilemmas is obtained. In one embodiment, such a dataset is collected via a moral machine framework. The moral machine framework, as used herein, refers to a framework for collecting human moral judgements regarding ethical dilemmas. Furthermore, in one embodiment, a reinforcement learning (RL) agent is trained using the dataset to determine a preferred ethical action in a given dilemma. As a result of such training, the trained RL agent is responsible for synthesizing the human-preferred choices from the dataset (derived from the moral machine framework) into a functional policy. That is, the training process essentially translates complex human moral judgments-often expressed as conflicting utilitarian versus deontological outcomes-into a mathematically quantifiable action policy for the autonomous vehicle. The preferred ethical action in a given action that was determined by the trained RL agent is then executed to control the autonomous vehicle (AV). For example, the RL agent's ethically-informed decisions directly govern the AV's behavior, such as steering or braking. Such an execution of the preferred ethical action translates the theoretical moral policy trained on human preferences into an on-the-road control command that influences the vehicle's operation in real-time. In this manner, moral decision-making capabilities of autonomous vehicles are enhanced.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

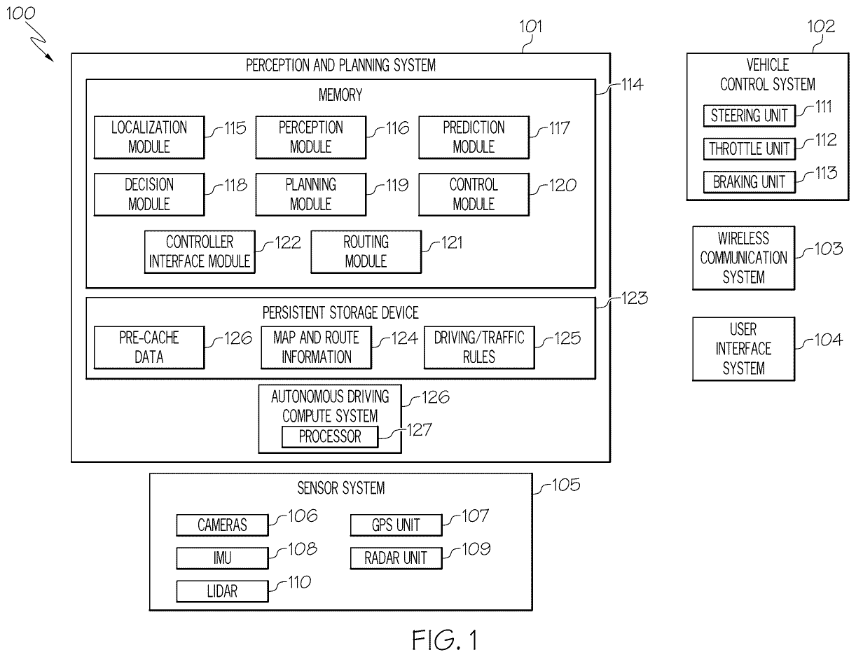

Referring now to the Figures in detail, FIG. 1 illustrates the internal components of an autonomous vehicle 100 in accordance with an embodiment of the present disclosure.

Autonomous vehicle 100, as used herein, refers to a vehicle capable of sensing its environment and operating without human involvement. A human passenger is not required to take control of the vehicle at any time, nor is a human passenger required to be present in the vehicle at all. Autonomous vehicle 100 can travel anywhere a traditional car can travel and do everything an experienced human driver does.

In one embodiment, autonomous vehicle 100 is configured with a set of computing resources. In one embodiment, autonomous vehicle 100 is configured to perform one or more transportation operations throughout various locations.

A description of the internal components of autonomous vehicle 100 is provided below.

As shown in FIG. 1, autonomous vehicle 100 includes, but is not limited to, perception and planning system 101, vehicle control system 102, wireless communication system 103, user interface system 104, and sensor system 105. Autonomous vehicle 100 may further include certain common components included in ordinary vehicles, such as, an engine, wheels, steering wheel, transmission, etc., which may be controlled by vehicle control system 102 and/or perception and planning system 101 using a variety of communication signals and/or commands, such as, for example, acceleration signals or commands, deceleration signals or commands, steering signals or commands, braking signals or commands, etc.

Components 101-105 may be communicatively coupled to each other via an interconnect, a bus, a network, or a combination thereof. For example, components 101-105 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

In one embodiment, sensor system 105 includes, but it is not limited to, one or more cameras 106, global positioning system (GPS) unit 107, inertial measurement unit (IMU) 108, radar unit 109, and a light detection and range (LiDAR) unit 110. GPS system 107 may include a transceiver operable to provide information regarding the position of autonomous vehicle 100. IMU unit 108 may sense position and orientation changes of autonomous vehicle 100 based on inertial acceleration. Radar unit 109 may represent a system that utilizes radio signals to sense objects within the local environment of autonomous vehicle 100. In one embodiment, in addition to sensing objects, radar unit 109 may additionally sense the speed and/or heading of the objects. LiDAR unit 110 may sense objects in the environment in which autonomous vehicle 100 is located using lasers. LiDAR unit 110 could include one or more laser sources, a laser scanner, and one or more detectors, among other system components. Cameras 106 may include one or more devices to capture images of the environment surrounding autonomous vehicle 100. Cameras 106 may be still cameras and/or video cameras. A camera may be mechanically movable, for example, by mounting the camera on a rotating and/or tilting a platform.

Sensor system 105 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 102 includes, but is not limited to, steering unit 111, throttle unit 112 (also referred to as an acceleration unit), and braking unit 113. Steering unit 111 is to adjust the direction or heading of the vehicle. Throttle unit 112 is to control the speed of the motor or engine that in turn controls the speed and acceleration of the vehicle. Braking unit 113 is to decelerate the vehicle by providing friction to slow the wheels or tires of the vehicle.

Furthermore, in one embodiment, wireless communication system 103 is to allow communication between autonomous vehicle 100 and external systems. For example, wireless communication system 103 can wirelessly communicate with one or more devices directly or via a communication network. Wireless communication system 103 can use any cellular communication network or a wireless local area network (WLAN) (e.g., using WiFi to communicate with another component or system). Wireless communication system 103 could communicate directly with a device (e.g., a speaker within autonomous vehicle 100), for example, using an infrared link, Bluetooth, etc.

User interface system 104 may be part of peripheral devices implemented within autonomous vehicle 100 including, for example, a keyboard, a touch screen display device, a microphone, a speaker, etc.

Some or all of the functions of autonomous vehicle 100 may be controlled or managed by perception and planning system 101, especially when operating in an autonomous driving mode. Perception and planning system 101 includes the necessary hardware (e.g., processor(s), memory, storage) and software (e.g., operating system, planning and routing programs) to receive information from sensor system 105, vehicle control system 102, wireless communication system 103, and/or user interface system 104, process the received information, plan a route or path from a starting point to a destination point, and then drive autonomous vehicle 100 based on the planning and control information. Alternatively, perception and planning system 101 may be integrated with vehicle control system 102.

For example, perception and planning system 101 obtains the trip related data. For instance, perception and planning system 101 may obtain location and route information from an intelligent transport system. Alternatively, such location and map services information may be cached locally in a persistent storage device of perception and planning system 101.

While autonomous vehicle 100 is moving along the route, perception and planning system 101 may also obtain real-time traffic information from the intelligent transport system, which obtained such information from a traffic information system or server (TIS). Based on the real-time traffic information, location information, as well as real-time local environment data detected or sensed by sensor system 105 (e.g., obstacles, objects, nearby vehicles), perception and planning system 101 can plan an optimal route, where perception and planning system 101 drives autonomous vehicle 100, for example, via vehicle control system 102, according to the planned route to reach the specified destination safely and efficiently.

In one embodiment, perception and planning system 101 includes a memory 114 for storing a localization module 115, perception module 116, prediction module 117, decision module 118, planning module 119, control module 120, routing module 121, and controller interface module 122.

In one embodiment, such modules (modules 115-122) are installed in persistent storage device 123, loaded into memory 114, and executed by one or more processors 127 of autonomous driving compute system 126 (discussed further below). It is noted that some or all of these modules may be communicatively coupled to or integrated with some or all modules of vehicle control system 102 of FIG. 1. Furthermore, in one embodiment, some of modules 115-122 may be integrated together as an integrated module.

In one embodiment, localization module 115 determines a current location of autonomous vehicle 100 (e.g., leveraging GPS unit 107) and manages any data related to a trip or route of autonomous vehicle 100. Localization module 115 (also referred to as a map and route module) manages any data related to a trip or route of autonomous vehicle 100. Localization module 115 communicates with other components of autonomous vehicle 100, such as map and route information 124, to obtain the trip related data. For example, localization module 115 may obtain location and route information from the intelligent transport system, which may be cached as part of map and route information 124. While autonomous vehicle 100 is moving along the route, localization module 115 may also obtain real-time traffic information from the intelligent transport system and/or a traffic information system or server.

Based on the sensor data provided by sensor system 105 and localization information obtained by localization module 115, a perception of the surrounding environment is determined by perception module 116. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 116 may include a computer vision system or functionalities of a computer vision system to process and analyze images captured by one or more cameras in order to identify objects and/or features in the environment of autonomous vehicle 100. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 116 can also detect objects based on other data provided by other sensors, such as a radar and/or LiDAR.

For each of the objects, prediction module 117 predicts what the object will behave under the circumstances. The prediction is performed based on perception module 116 perceiving the driving environment at the point in time in view of a set of map and route information 124 and driving/traffic rules 125. For example, if the object is a vehicle at an opposing direction and the current driving environment includes an intersection, prediction module 117 will predict whether the vehicle will likely move straight forward or make a turn. If the perception data indicates that the intersection has no traffic light, prediction module 117 may predict that the vehicle may have to fully stop prior to entering the intersection. If the perception data indicates that the vehicle is currently at a left-turn only lane or a right-turn only lane, prediction module 117 may predict that the vehicle will more likely make a left turn or right turn respectively.

For each of the objects, decision module 118 makes a decision regarding how to handle the object. For example, for a particular object (e.g., another vehicle in a crossing route) as well as its metadata describing the object (e.g., a speed, direction, turning angle), decision module 118 decides how to encounter the object (e.g., overtake, yield, stop, pass). Decision module 118 may make such decisions according to a set of rules, such as traffic rules or driving rules 125, which may be stored in persistent storage device 123.

In one embodiment, routing module 121 is configured to provide one or more routes or paths from a starting point to a destination point. In one embodiment, for a given trip from a start location to a destination location, routing module 121 obtains map and route information 124 and determines all possible routes or paths from the starting location to reach the destination location. Routing module 121 may generate a reference line in a form of a topographic map for each of the routes it determines from the starting location to reach the destination location. A reference line refers to an ideal route or path without any interference from others, such as other vehicles, obstacles, or traffic conditions. That is, if there is no other vehicle, pedestrians, or obstacles on the road, autonomous vehicle 100 should exactly or closely follow the reference line. The topographic maps are then provided to decision module 118 and/or planning module 119. Decision module 118 and/or planning module 119 examine all of the possible routes to select and modify one of the most optimal routes in view of other data provided by other modules, such as traffic conditions from localization module 115, driving environment perceived by perception module 116, and traffic conditions predicted by prediction module 117. The actual path or route for controlling autonomous vehicle 100 may be close to or different from the reference line provided by routing module 121 dependent upon the specific driving environment at the point in time.

Based on a decision for each of the objects perceived, planning module 119 plans a path or route for autonomous vehicle 100 as well as driving parameters (e.g., distance, speed, and/or turning angle) using a reference line provided by routing module 121 as a basis.

In one embodiment, for a given object, decision module 118 decides what to do with the object, while planning module 119 determines how to do it. For example, for a given object, decision module 118 may decide to pass the object, while planning module 119 may determine whether to pass on the left side or right side of the object. Planning and control data is generated by planning module 119 including information describing how autonomous vehicle 100 would move in a next moving cycle (e.g., next route/path segment). For example, the planning and control data may instruct autonomous vehicle 100 to move 10 meters at a speed of 30 miles per hour (mph), then change to a right lane at the speed of 25 mph.

Based on the planning and control data, control module 120 controls and drives autonomous vehicle 100, by sending proper commands or signals to vehicle control system 102, according to a route or path defined by the planning and control data. The planning and control data includes sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 119 plans a next route segment or path segment, for example, including a target position and the time required for autonomous vehicle 100 to reach the target position. Alternatively, planning module 119 may further specify the specific speed, direction, and/or steering angle, etc. In one embodiment, planning module 119 plans a route segment or path segment for the next predetermined period of time, such as 5 seconds. For each planning cycle, planning module 119 plans a target position for the current cycle (e.g., next 5 seconds) based on a target position planned in a previous cycle. Control module 120 then generates one or more control commands (e.g., throttle, brake, steering control commands) based on the planning and control data of the current cycle.

It is noted that decision module 118 and planning module 119 may be integrated as an integrated module. Decision module 118/planning module 119 may include a navigation system or functionalities of a navigation system to determine a driving path for autonomous vehicle 100. For example, the navigation system may determine a series of speeds and directional headings to affect movement of autonomous vehicle 100 along a path that substantially avoids perceived obstacles while generally advancing autonomous vehicle 100 along a roadway-based path leading to an ultimate destination. The navigation system may update the driving path dynamically while autonomous vehicle 100 is in operation. The navigation system can incorporate data from a GPS system and one or more maps so as to determine the driving path for autonomous vehicle 100.

In one embodiment, perception and planning system 101 further includes autonomous driving compute system 126 configured to issue commands to control module 120 to control autonomous vehicle 100. Control module 120 may generate control signals to operate autonomous vehicle 100 in accordance with the commands received from autonomous driving compute system 126.

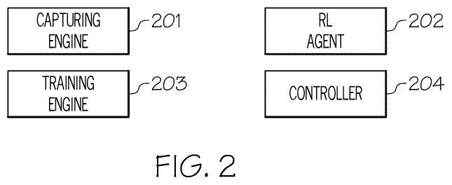

In one embodiment, autonomous driving compute system 126 is configured to enhance moral decision-making capabilities of autonomous vehicles as discussed further below. Furthermore, a discussion regarding the software components used by autonomous driving compute system 126 to enhance moral decision-making capabilities of autonomous vehicles is provided below in connection with FIG. 2. The instructions produced by such software components are executed by processor(s) 127.

FIG. 2 is a diagram of the software components used by autonomous driving compute system 126 to enhance moral decision-making capabilities of autonomous vehicles in accordance with an embodiment of the present disclosure.

Referring to FIG. 2, in conjunction with FIG. 1, autonomous driving compute system 126 includes capturing engine 201 configured to obtain a dataset of moral judgements regarding autonomous vehicle ethical dilemmas, where the dataset is collected via a moral machine framework.

In one embodiment, capturing engine 201 obtains a dataset of moral judgements regarding autonomous vehicle ethical dilemmas by collecting and structuring empirical human preference data on high-stakes AV scenarios.

In one embodiment, such a process involves utilizing a moral machine framework (data source) and quantifying human references. In one embodiment, capturing engine 201 sources data from a moral machine framework. A moral machine framework, as used herein, refers to a framework for collecting human moral judgements regarding ethical dilemmas.

In one embodiment, capturing engine 201 captures a publicly available dataset generated by the moral machine framework. In one embodiment, such a dataset is composed of millions of pairwise decisions (e.g., “save X pedestrians or save Y occupants”) across various ethical dilemmas (e.g., “trolley problems”).

In one embodiment, capturing engine 201 filters the raw data (data from the dataset generated by the moral machine framework) to isolate relevant scenarios, such as the classic trolley scenario (1-vs-X) and the modified double scenario (2-vs-X). In one embodiment, the data also includes associated demographic information (e.g., age and gender) for the participants, which is later used to train the large language models (LLMs) to model or simulate demographic differences.

As discussed above, capturing engine 201 is configured to quantify human preferences. In such an embodiment, after obtaining the raw choices, capturing engine 201 transforms the data into a usable format for reinforcement learning (RL) agent 202 (discussed further below).

Furthermore, autonomous driving compute system 126 includes training engine 203 configured to train reinforcement learning (RL) agent 202 using the dataset to determine a preferred ethical action in a given dilemma. RL agent 202, as used herein, refers to the decision-making entity that interacts with an environment to achieve a goal by learning through trial and error.

In one embodiment, such training involves constructing the ethical reward function to guide the RL agent's learning to determine a preferred ethical action in a given dilemma. In one embodiment, such a construction involves training engine 203 quantifying an ethical outcome of potential actions under the utilitarian and deontological theories by assigning numerical severity weights to different actions within specific moral scenarios. In such an embodiment, training engine 203 defines the intrinsic rewards (Wᵢ) for each ethical theory (e.g., utilitarian, deontological).

In one embodiment, training engine 203 implements numerical severity weights by hard-coding or pre-defining the costs (negative rewards, or “severity weights”) associated with the potential actions in a specific moral scenario, such as judged strictly by the principles of utilitarianism and deontology. In one embodiment, this quantification creates the choice-worthiness function (Wᵢ) for each theory.

In one embodiment, the numerical severity weights are assigned to different actions within specific moral scenarios by first defining the moral scenarios. For example, in one embodiment, training engine 203 identifies the specific, simplified scenarios RL agent 202 will face, such as those modeled after the classic and double trolley problems. An example of the classic trolly problem is having one individual on the alternate path vs. X individuals on the main path (1-vs-X). An example of the double trolley problem is having two individuals on the alternate path vs. X individuals on the main path (2-vs-X).

In one embodiment, training engine 203 assigns weights based on utilitarianism. The utilitarian weight focuses on the consequences of the action, specifically aiming to minimize the total harm (the number of lives lost). The numerical severity weight assigned is the negative count of individuals killed by that action. For example, the action of switching (the AV actively changes its course, such as steering off the current path, flipping a metaphorical trolley switch, to divert the imminent crash onto an alternate path) resulting in the crash into 1 person is assigned the severity weight (W_{Utilitarian}) of −1 based on the utilitarian principle of such an action resulting in the death of 1 person. In another example, the action of switching (the AV actively changes its course, such as steering off the current path, flipping a metaphorical trolley switch, to divert the imminent crash onto an alternate path) resulting in the crash into 2 people is assigned the severity weight (Wᵤₜᵢₗᵢₜₐᵣᵢₐₙ) of −2 based on the utilitarian principle of such an action resulting in the death of 2 people. In a further example, the action of doing nothing (the AV maintains its current course and speed allowing the crash to occur on the path it is currently on) resulting in the crash into X people is assigned the severity weight (Wᵤₜᵢₗᵢₜₐᵣᵢₐₙ) of −X based on the utilitarian principle of such an action resulting in the death of X people.

In one embodiment, training engine 203 assigns weights based on deontology. The deontological weight focuses on the inherent morality of the action, independent of the outcome, emphasizing rules and obligations (e.g., the moral rule against actively causing direct harm). For example, the action of switching (the AV actively changes its course, such as steering off the current path, flipping a metaphorical trolley switch, to divert the imminent crash onto an alternate path) resulting in the crash into 1 person is assigned the severity weight (W_{Deontology}) of −1 based on the deontological principle of such an action causing direct harm. In another example, the action of switching (the AV actively changes its course, such as steering off the current path, flipping a metaphorical trolley switch, to divert the imminent crash onto an alternate path) resulting in the crash into 2 people is assigned the severity weight (W_{Deontology}) of −1 based on the deontological principle of such an action causing direct harm. In a further example, the action of doing nothing (the AV maintains its current course and speed allowing the crash to occur on the path it is currently on) resulting in the crash into X people is assigned the severity weight (W_{Deontology}) of 0 based on the deontological principle that such inaction leads to harm.

In one embodiment, the objective of the training process is to maximize the ethical reward function R(s,a,s′), which is constructed by combining the human-preferred credence values (Cᵢ) and the theory-specific choice-worthiness functions (Wᵢ). This reward function formally embeds human moral consensus into the objective of RL agent 202. The total ethical reward for taking action a in state s and transitioning to state s′ is defined as the credence-weighted sum:

$$R ( s , a , {s}^{′} ) = {\sum }_{i} {C}_{i} {W}_{i} ( s , a , {s}^{′} )$$

where Wᵢ represents the fixed numerical severity weights defined by ethical theory i (as discussed above) and Cᵢ represents the human-preferred credence value for theory i (to be determined by the Bradley-Terry model as discussed further below). This integrated function is the fundamental mechanism used by training engine 203 to guide RL agent 202 toward an empirically aligned moral policy.

In one embodiment, training engine 203 quantifies human preference within the dataset by integrating the Bradley-Terry (BT) model within the moral machine framework to perform pairwise comparison on moral scenarios and generate strength parameters for potential actions.

In one embodiment, the BT model is implemented to transition from raw counts of human choices to a mathematically quantifiable “strength” or preference for one action over another in a moral dilemma. This process effectively converts binary human choices into continuous, comparative ethical weights.

In one embodiment, the input for the BT model comes directly from the filtered moral machine dataset, which provides aggregated pairwise comparisons. For example, for any given moral scenario (e.g., the 1-vs-3 trolley problem), there is Action A: the number of times humans chose to switch (utilitarian choice), and Action B: the number of times humans chose to do nothing (deontological choice).

The BT model, as used herein, refers to a probability model used in statistics to determine the relative strengths or abilities of items being compared pairwise. In this context, the “items” are the potential actions (i and j) in the moral dilemma.

In one embodiment, the BT model calculates the probability that action i is chosen over action j based on their inherent strength parameters (βᵢ and βⱼ):

$${p}_{ij} = \frac{{e}^{{β}_{i}}}{{e}^{{β}_{i}} + {e}^{{β}_{j}}}$$

In one embodiment, training engine 203 uses maximum likelihood estimation (MLE) on the observed human choice counts (pᵢⱼ) to solve for the strength parameters (βᵢ and βⱼ).

In one embodiment, a larger β value for a specific action indicates a higher preference (or strength) for that action among the human participants.

In one embodiment, the resulting β values are the strength parameters for potential actions. For example, in a 1-vs-3 scenario: the following are the strength parameters: β_{switch} (strength of the utilitarian-aligned action) and β_{do nothing} (strength of the deontological-aligned action). These β values intrinsically quantify human preference. For example, if β_{switch} is significantly higher, it means the human collective preference strongly favored the utilitarian outcome in that specific dilemma. These parameters are then immediately used to generate the credence values (Cᵢ), which are the final ethical weights injected into the RL agent's reward function as discussed further below.

In one embodiment, training engine 203 is configured to convert the generated strength parameters (β) into credence values (Cᵢ).

In one embodiment, training engine 203 converts the generated strength parameters (β) into credence values (Cᵢ) by normalizing and interpreting the BT model's output in the context of the ethical theories guiding reinforcement learning (RL) agent 202 This conversion translates the statistical preference for an action into a degree of belief or weight assigned to a specific ethical framework (e.g., utilitarianism, deontology) for that particular moral scenario. Utilitarianism, as used herein, refers to an ethical theory that judges the morality of an action based on its outcomes, specifically by whether it produces the greatest happiness for the greatest number of people. Deontology, as used herein, refers to an ethical theory that judges the morality of an action based on its adherence to rules or duties rather than the consequences of the action.

In one embodiment, training engine 203 converts the generated strength parameters (β) into credence values (Cᵢ) by mapping the strength parameters (β) back to the ethical theories (e.g., utilitarianism and deontology) addressed by the RL framework. In such an embodiment, the strength parameters generated by the Bradley-Terry (BT) model are associated with the ethical theories they represent for the given dilemma. For example, if Action A (e.g., “switch the trolley”) is generally aligned with utilitarianism (maximizing total saved lives), then the strength β_{A} is mapped to the potential strength of the utilitarian theory. In another example, if Action B (e.g., “do nothing”) is generally aligned with deontology (adherence to the rule against causing direct harm), then the strength β_{B} is mapped to the potential strength of the deontological theory.

In one embodiment, credence values (Cᵢ) are defined as a probability distribution or a normalized weight (i.e., the credence values must sum to 1 (or 100%) across all ethical theories considered by RL agent 202 in that moment). In one embodiment, the strength parameters (β) are used to calculate the fractional weight or credence (Cᵢ) for each theory. In one embodiment, training engine 203 uses a softmax-like function or a simple normalization of the strengths, ensuring:

$${\sum }_{i} {C}_{i} = 1$$

where i represents the ethical theories (e.g., utilitarianism and deontology).

For a specific moral scenario, the output is a pair of credence values, such as C_{Utilitarian}=0.7 and C_{Deontology}=0.3. This signifies that based on human preferences, the decision-making should be weighted 70% toward utilitarian principles and 30% toward deontological principles.

Furthermore, in one embodiment, training engine 203 integrates the credence values into a reward function of RL agent 202 to guide its decision-making process.

In one embodiment, once the credence values are generated, training engine 203 utilizes the credence values to construct the ethical reward function R(s,a,s′) for RL agent 202, as defined below:

$$R ( s , a , {s}^{′} ) = {\sum }_{i} {C}_{i} {W}_{i} ( s , a , {s}^{′} )$$

where Wᵢ is the choice-worthiness function (reward) defined by theory i, and Cᵢ is the newly derived human-preferred credence value for that theory.

By converting β to Cᵢ, the system effectively ensures that the RL agent's learning is guided by the empirical moral consensus of the human population for that exact dilemma rather than by fixed, equal, or random weights.

Furthermore, in connection with training engine 203 integrating the credence values into a reward function of RL agent 202 to guide its decision-making process, training engine 203 defines RL agent's overall ethical reward function as a credence-weighted sum of the choice-worthiness functions derived from the multiple ethical theories RL agent 202 considers (e.g., utilitarianism and deontology). For example, in one embodiment, the overall reward R(s,a,s′) that RL agent 202 seeks to maximize for taking action a in state s and transitioning to state s′ is constructed as a linear combination of the individual ethical theories' value functions, weighted by the human-preferred credence:

$$R ( s , a , {s}^{′} ) = {\sum }_{i} {C}_{i} {W}_{i} ( s , a , {s}^{′} )$$

where R(s,a,s′) is the total ethical reward received by RL agent 202 for a state transition. Furthermore, Cᵢ is the credence value derived from the Bradley-Terry model (and human preference data) for a specific ethical theory i (C_{Utilitarian}). These values ensure that ΣCᵢ=1. Additionally, Wᵢ(s,a,s′) is a choice-worthiness function (or intrinsic reward) for ethical theory i. This function is based on the hard-coded numerical severity weights (e.g., −1, −X) assigned to different actions under utilitarianism or deontology for that specific moral scenario.

By using this constructed reward function, training engine 203 guides RL agent 202 to prioritize actions that maximize the weighted sum of ethical outcomes. For example, if human preference for a scenario dictates C_{Utilitarian} is high (e.g., 0.8), then the reward of RL agent 202 will be heavily influenced by the utilitarian choice-worthiness W_{Utilitarian}. Conversely, if C_{Deontology} is high, then RL agent 202 will learn to favor actions that minimize direct harm, aligning with deontological rules.

This process ensures the agent's learned policy, which determines its “preferred ethical action,” directly aligns with the empirical human moral consensus quantified by the credence values rather than relying on a fixed or arbitrary 50/50 split between ethical theories.

In one embodiment, in connection with training engine 203 incorporating ethical theories and large language models (LLMs) in training RL agent 202, training engine 203 utilizes a large language model (LLM) to simulate complex moral reasoning based on the dataset by considering demographic distinctions in human preferences. By utilizing the LLM to simulate complex moral reasoning, AV systems are able to adapt to nuanced human factors, such as age and gender, in ethical decision-making.

In one embodiment, he LLM simulation is guided by engineered prompts that direct the LLM to consider ethical theories (e.g., utilitarian, deontological) to enhance human-value alignment of ethical decisions.

In one embodiment, training engine 203 utilizes the LLM as a sophisticated reasoning engine that can process ethical frameworks and demographic variables simultaneously thereby allowing the system to model how human moral choices shift across different groups.

In one embodiment, training engine 203 implements the LLM for demographic-aware simulation using prompt engineering. Prompt engineering, as used herein, is a process of designing and refining instructions (prompts) for generative AI models to elicit desired and accurate outputs. In such an embodiment, the LLM is not simply asked to make a choice. Instead, it is guided to simulate the reasoning process.

For example, in the embodiment of using prompt engineering, training engine 203 constructs scenario prompts. For instance, training engine 203 takes a specific moral dilemma (e.g., “A crash is imminent; the choice is between hitting a 70-year-old man or a 10-year-old boy.”) from the dataset.

In another example, in the embodiment of using prompt engineering, training engine 203 injects ethical theories. For instance, training engine 203 utilizes prompts that are engineered to instruct the LLM to analyze the scenario by considering a plurality of ethical theories (e.g., justice, deontology, virtue ethics, commonsense morality, utilitarianism, etc.) thereby forcing the LLM to move beyond a single rule.

In a further example, in the embodiment of using prompt engineering, training engine 203 integrates demographic context. For instance, training engine 203 utilizes prompts that explicitly include the demographic distinctions (age, gender, etc.) of the victims/occupants and asks the LLM to justify its action based on these factors and the ethical theories.

In one embodiment, the LLM processes the engineered prompt to generate two critical outputs: action preference and detailed justifications. The action preference corresponds to the LLM's simulated choice (e.g., “save the boy,” reflecting a preference for youth). The detailed justification corresponds to the LLM providing a step-by-step, transparent explanation (Chain of Thought (CoT) reasoning) for its decision, referencing the ethical theories and demographic factors.

In one embodiment, the LLM's simulated results are then used to enhance the final moral policy of RL agent 202. For example, in one embodiment, the LLM's simulated results are used to enhance the final moral policy of RL agent 202 by modeling the demographic bias. In one embodiment, the LLM's output provides data on how moral decisions vary by age and gender, allowing the system to identify and model these demographic-based decision biases. For example, if the LLM consistently favors younger individuals, this pattern can be quantified.

In another example, the LLM's simulated results enhance the final moral policy of RL agent 202 by enhancing alignment and transparency. By analyzing the LLM's justifications, training engine 203 ensures that the final decisions align with human moral intuitions (the goal of the original dataset) and provides a mechanism for transparent explanation and accountability that traditional RL methods lack.

In essence, the LLM acts as an ethical interpreter, translating the static human preference data into a dynamic model capable of generalized, demographically-aware ethical reasoning that the final AV control system can leverage.

Furthermore, in one embodiment, training engine 203 guides a voting mechanism by the credence values (human-preferred credence values derived from the dataset) to influence decision-making of RL agent 202.

In one embodiment, training engine 203 uses the human-derived credence values (Cᵢ) as weights to influence the outcome of the ethical voting mechanism (e.g., Nash voting or variance voting), which resolves the “moral uncertainty” inherent in the dilemma.

In one embodiment, training engine 203 implements one or more weighted voting mechanisms, such as Nash voting or variance voting. In one embodiment, the Nash voting mechanism views ethical theories (e.g., utilitarianism, deontology) as competing agents that cast votes for or against available actions. The agents have a budget, and the cost of voting is proportional to the size of their vote. The variance voting mechanism, on the other hand, is a mechanism that prioritizes actions with lower variance in their expected outcomes across different ethical theories thereby choosing actions with a more cooperative or balanced risk profile.

In one embodiment, training engine 203 links the human-preferred credence values (Cᵢ) to the voting process thereby ensuring the final decision reflects human consensus. For example, with the Nash voting mechanism, the total voting budget or the influence of the votes caste by each ethical theory is scaled proportionally to its credence value (Cᵢ). A theory with a higher Cᵢ (reflecting stronger human preference) has a greater effective influence on the outcome of the vote thereby effectively embodying the principle of proportional say. The principle of proportional say dictates that when an agent, such as RL agent 202, is balancing different, often conflicting, ethical theories (e.g., utilitarianism and deontology), the influence of each theory on the final decision should be adjusted proportionally to its credence (Cᵢ), or the degree of belief assigned to it.

In another example, with the variance voting mechanism, the Q-values of each theory, which represents the preference of that theory, are normalized (variance-normalized) before voting. The Q-values of each theory (Q_{y}(s,a)) represent the expected, discounted cumulative choice-worthiness (or reward) for an ethical theory i, starting from state s and taking action a, under a given policy π.

In one embodiment, Q_{y}(s,a) is a metric unique to each ethical theory i (e.g., utilitarianism, deontology). It quantifies the long-term goodness of an action strictly from that theory's perspective.

In one embodiment, the Q-value for theory i is:

$${Q}_{i} ( s , a ) = E [ {\sum }_{t = 0}^{∞} {γ}^{t} {W}_{i} ( {s}_{t} , {a}_{t} , {s}_{t + 1} ) \vert {s}_{0} = s , {a}_{0} = a ]$$

where Wᵢ is the choice-worthiness function (immediate reward) defined by theory i, and γ is the discount factor (how much future rewards are valued). In one embodiment, in the variance voting mechanism, these Q_{y}(s,a) values are considered the “preferences” of that theory for a given action. They are learned during the RL training process and are then used to calculate the variance and guide the final ethical decision.

In one embodiment, after the voting mechanism processes the preferences and weights, the mechanism outputs a final decision (e.g., “switch” or “do nothing”) that represents the ethically preferred action, considering both the intrinsic rewards of the ethical theories and the human-preferred credence weights. This resulting decision is the preferred ethical action that RL agent 202 determines and is subsequently executed to control autonomous vehicle 100.

Autonomous driving compute system 126 additionally includes controller 204 configured to execute the preferred ethical action determined by the trained RL agent 202 to control autonomous vehicle (AV) 100.

In one embodiment, controller 204 implements two phases, decision translation and vehicle control, to execute the preferred ethical action determined by the trained RL agent 202 to control AV 100.

In the decision translation phase, controller 204 receives the output from the decision-making system (trained RL agent 202, guided by human-preferred credence and voting mechanisms) in a high-level format. For example, the input corresponds to the final determination by RL agent 202, which is the preferred ethical action (e.g., “switch” or “do nothing”). Controller 204 then maps this abstract ethical command to specific, quantifiable vehicle maneuvers. For example, if the output is “switch,” then controller 204 translates this into commands for the vehicle's actuators, such as turn the steering wheel X degrees left and apply Y percent braking. In another example, if the output is “do nothing,” then controller 204 translates this into commands to maintain the current steering angle and maintain the current acceleration/deceleration profile.

In one embodiment, in the phase of vehicle control, controller 204 uses these translated commands to directly govern the AV's safety-critical systems in real-time. For example, controller 204 may send the signals to control module 120 of autonomous vehicle 100, which generates the appropriate commands, which are sent to vehicle control system 102 to control the AV's physical control systems (actuators) for steering (controlling the vehicle's lateral movement) and braking/acceleration (controlling the vehicle's longitudinal speed).

Furthermore, by performing such operations in real-time, the real-time execution ensures that the AV's physical behavior in the high-stakes dilemma is an on-the-road realization of the theoretical moral policy. This action determines the final outcome of the crash, aligning the vehicle's behavior with the ethical policy trained on societal moral standards.

In this manner, moral decision-making capabilities of autonomous vehicles are enhanced.

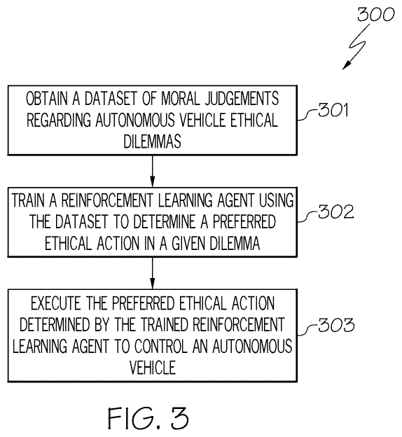

A discussion regarding the method for enhancing more decision-making capabilities of autonomous vehicles is provided below in connection with FIG. 3.

FIG. 3 is a flowchart of a method 300 for enhancing more decision-making capabilities of autonomous vehicles in accordance with an embodiment of the present disclosure.

Referring to FIG. 3, in conjunction with FIGS. 1-2, in step 301, capturing engine 201 obtains a dataset of moral judgements regarding autonomous vehicle ethical dilemmas, where the dataset is collected via a moral machine framework.

As stated above, in one embodiment, capturing engine 201 obtains a dataset of moral judgements regarding autonomous vehicle ethical dilemmas by collecting and structuring empirical human preference data on high-stakes AV scenarios.

In one embodiment, such a process involves utilizing a moral machine framework (data source) and quantifying human references. In one embodiment, capturing engine 201 sources data from a moral machine framework. A moral machine framework, as used herein, refers to a framework for collecting human moral judgements regarding ethical dilemmas.

In one embodiment, capturing engine 201 captures a publicly available dataset generated by the moral machine framework. In one embodiment, such a dataset is composed of millions of pairwise decisions (e.g., “save X pedestrians or save Y occupants”) across various ethical dilemmas (e.g., “trolley problems”).

In one embodiment, capturing engine 201 filters the raw data (data from the dataset generated by the moral machine framework) to isolate relevant scenarios, such as the classic trolley scenario (1-vs-X) and the modified double scenario (2-vs-X). In one embodiment, the data also includes associated demographic information (e.g., age and gender) for the participants, which is later used to train the large language models (LLMs) to model or simulate demographic differences.

As discussed above, capturing engine 201 is configured to quantify human preferences. In such an embodiment, after obtaining the raw choices, capturing engine 201 transforms the data into a usable format for reinforcement learning (RL) agent 202.

In step 302, training engine 203 trains reinforcement learning (RL) agent 202 using the dataset to determine a preferred ethical action in a given dilemma. RL agent 202, as used herein, refers to the decision-making entity that interacts with an environment to achieve a goal by learning through trial and error.

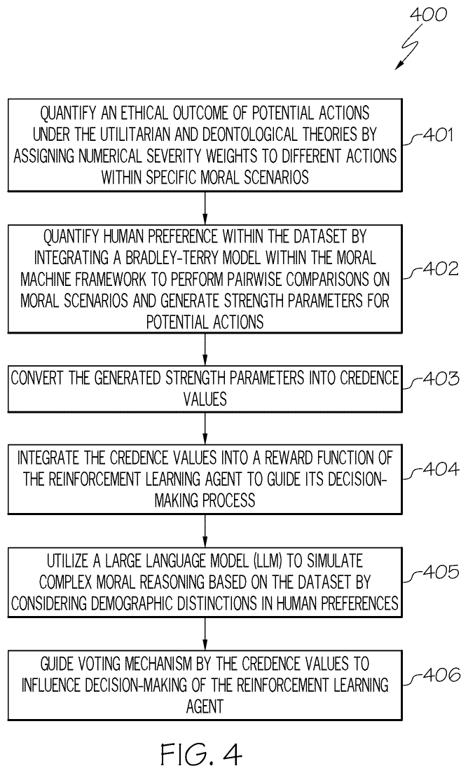

A further discussion regarding training RL agent to determine a preferred ethical action in a given dilemma, including constructing the ethical reward function to guide the RL agent's learning to determine a preferred ethical action in a given dilemma, is provided below in connection with FIG. 4.

FIG. 4 is a flowchart of a method 400 for training RL agent to determine a preferred ethical action in a given dilemma in accordance with an embodiment of the present disclosure.

Referring to FIG. 4, in conjunction with FIGS. 1-3, in step 401, training engine 203 quantifies an ethical outcome of potential actions under the utilitarian and deontological theories by assigning numerical severity weights to different actions within specific moral scenarios.

As stated above, in such an embodiment, training engine 203 defines the intrinsic rewards (Wᵢ) for each ethical theory (e.g., utilitarian, deontological).

Furthermore, in one embodiment, training engine 203 implements numerical severity weights by hard-coding or pre-defining the costs (negative rewards, or “severity weights”) associated with the potential actions in a specific moral scenario, such as judged strictly by the principles of utilitarianism and deontology. In one embodiment, this quantification creates the choice-worthiness function (Wᵢ) for each theory.

In one embodiment, the numerical severity weights are assigned to different actions within specific moral scenarios by first defining the moral scenarios. For example, in one embodiment, training engine 203 identifies the specific, simplified scenarios RL agent 202 will face, such as those modeled after the classic and double trolley problems. An example of the classic trolly problem is having one individual on the alternate path vs. X individuals on the main path (1-vs-X). An example of the double trolley problem is having two individuals on the alternate path vs. X individuals on the main path (2-vs-X).

In one embodiment, training engine 203 assigns weights based on utilitarianism. The utilitarian weight focuses on the consequences of the action, specifically aiming to minimize the total harm (the number of lives lost). The numerical severity weight assigned is the negative count of individuals killed by that action. For example, the action of switching (the AV actively changes its course, such as steering off the current path, flipping a metaphorical trolley switch, to divert the imminent crash onto an alternate path) resulting in the crash into 1 person is assigned the severity weight (W_{Utilitarian}) of −1 based on the utilitarian principle of such an action resulting in the death of 1 person. In another example, the action of switching (the AV actively changes its course, such as steering off the current path, flipping a metaphorical trolley switch, to divert the imminent crash onto an alternate path) resulting in the crash into 2 people is assigned the severity weight (W_{Utilitarian}) of −2 based on the utilitarian principle of such an action resulting in the death of 2 people. In a further example, the action of doing nothing (the AV maintains its current course and speed allowing the crash to occur on the path it is currently on) resulting in the crash into X people is assigned the severity weight (W_{Utilitarian}) of −X based on the utilitarian principle of such an action resulting in the death of X people.

In one embodiment, training engine 203 assigns weights based on deontology. The deontological weight focuses on the inherent morality of the action, independent of the outcome, emphasizing rules and obligations (e.g., the moral rule against actively causing direct harm). For example, the action of switching (the AV actively changes its course, such as steering off the current path, flipping a metaphorical trolley switch, to divert the imminent crash onto an alternate path) resulting in the crash into 1 person is assigned the severity weight (W_{Deontology}) of −1 based on the deontological principle of such an action causing direct harm. In another example, the action of switching (the AV actively changes its course, such as steering off the current path, flipping a metaphorical trolley switch, to divert the imminent crash onto an alternate path) resulting in the crash into 2 people is assigned the severity weight (W_{Deontology}) of −1 based on the deontological principle of such an action causing direct harm. In a further example, the action of doing nothing (the AV maintains its current course and speed allowing the crash to occur on the path it is currently on) resulting in the crash into X people is assigned the severity weight (W_{Deontology}) of 0 based on the deontological principle that such inaction leads to harm.

In one embodiment, the objective of the training process is to maximize the ethical reward function R(s,a,s′), which is constructed by combining the human-preferred credence values (Cᵢ) and the theory-specific choice-worthiness functions (Wᵢ). This reward function formally embeds human moral consensus into the objective of RL agent 202. The total ethical reward for taking action a in state s and transitioning to state s′ is defined as the credence-weighted sum:

$$R ( s , a , {s}^{′} ) = {\sum }_{i} {C}_{i} {W}_{i} ( s , a , {s}^{′} )$$

where Wᵢ represents the fixed numerical severity weights defined by ethical theory i (as discussed above) and Cᵢ represents the human-preferred credence value for theory i (to be determined by the Bradley-Terry model). This integrated function is the fundamental mechanism used by training engine 203 to guide RL agent 202 toward an empirically aligned moral policy.

In step 402, training engine 203 quantifies human preference within the dataset by integrating the Bradley-Terry (BT) model within the moral machine framework to perform pairwise comparison on moral scenarios and generate strength parameters for potential actions.

As discussed above, in one embodiment, the BT model is implemented to transition from raw counts of human choices to a mathematically quantifiable “strength” or preference for one action over another in a moral dilemma. This process effectively converts binary human choices into continuous, comparative ethical weights.

In one embodiment, the input for the BT model comes directly from the filtered moral machine dataset, which provides aggregated pairwise comparisons. For example, for any given moral scenario (e.g., the 1-vs-3 trolley problem), there is Action A: the number of times humans chose to switch (utilitarian choice), and Action B: the number of times humans chose to do nothing (deontological choice).

The BT model, as used herein, refers to a probability model used in statistics to determine the relative strengths or abilities of items being compared pairwise. In this context, the “items” are the potential actions (i and j) in the moral dilemma.

In one embodiment, the BT model calculates the probability that action i is chosen over action j based on their inherent strength parameters (βᵢ and βⱼ):

$${p}_{ij} = \frac{{e}^{{β}_{i}}}{{e}^{{β}_{i}} + {e}^{{β}_{j}}}$$

In one embodiment, training engine 203 uses maximum likelihood estimation (MLE) on the observed human choice counts (pᵢⱼ) to solve for the strength parameters (βᵢ and βⱼ).

In one embodiment, a larger β value for a specific action indicates a higher preference (or strength) for that action among the human participants.

In one embodiment, the resulting β values are the strength parameters for potential actions. For example, in a 1-vs-3 scenario: the following are the strength parameters: β_{switch} (strength of the utilitarian-aligned action) and β_{do nothing} (strength of the deontological-aligned action). These β values intrinsically quantify human preference. For example, if β_{switch} is significantly higher, it means the human collective preference strongly favored the utilitarian outcome in that specific dilemma. These parameters are then immediately used to generate the credence values (Cᵢ), which are the final ethical weights injected into the RL agent's reward function.

In step 403, training engine 203 converts the generated strength parameters (β) into credence values (Cᵢ).

As stated above, in one embodiment, training engine 203 converts the generated strength parameters (β) into credence values (Cᵢ) by normalizing and interpreting the BT model's output in the context of the ethical theories guiding reinforcement learning (RL) agent 202. This conversion translates the statistical preference for an action into a degree of belief or weight assigned to a specific ethical framework (e.g., utilitarianism, deontology) for that particular moral scenario. Utilitarianism, as used herein, refers to an ethical theory that judges the morality of an action based on its outcomes, specifically by whether it produces the greatest happiness for the greatest number of people. Deontology, as used herein, refers to an ethical theory that judges the morality of an action based on its adherence to rules or duties rather than the consequences of the action.

In one embodiment, training engine 203 converts the generated strength parameters (β) into credence values (Cᵢ) by mapping the strength parameters (β) back to the ethical theories (e.g., utilitarianism and deontology) addressed by the RL framework. In such an embodiment, the strength parameters generated by the Bradley-Terry (BT) model are associated with the ethical theories they represent for the given dilemma. For example, if Action A (e.g., “switch the trolley”) is generally aligned with utilitarianism (maximizing total saved lives), then the strength β_{A} is mapped to the potential strength of the utilitarian theory. In another example, if Action B (e.g., “do nothing”) is generally aligned with deontology (adherence to the rule against causing direct harm), then the strength β_{B} is mapped to the potential strength of the deontological theory.

In one embodiment, credence values (Cᵢ) are defined as a probability distribution or a normalized weight (i.e., the credence values must sum to 1 (or 100%) across all ethical theories considered by RL agent 202 in that moment). In one embodiment, the strength parameters (β) are used to calculate the fractional weight or credence (Ci) for each theory. In one embodiment, training engine 203 uses a softmax-like function or a simple normalization of the strengths, ensuring:

$${\sum }_{i} {C}_{i} = 1$$

where i represents the ethical theories (e.g., utilitarianism and deontology).

For a specific moral scenario, the output is a pair of credence values, such as C_{Utilitarian}=0.7 and C_{Deontology}=0.3. This signifies that based on human preferences, the decision-making should be weighted 70% toward utilitarian principles and 30% toward deontological principles.

Furthermore, in one embodiment, training engine 203 integrates the credence values into a reward function of RL agent 202 to guide its decision-making process.

In one embodiment, once the credence values are generated, training engine 203 utilizes the credence values to construct the ethical reward function R(s,a,s′) for RL agent 202, as defined below:

$$R ( s , a , {s}^{′} ) = {\sum }_{i} {C}_{i} {W}_{i} ( s , a , {s}^{′} )$$

where Wᵢ is the choice-worthiness function (reward) defined by theory i, and Cᵢ is the newly derived human-preferred credence value for that theory.

By converting β to Cᵢ, the system effectively ensures that the RL agent's learning is guided by the empirical moral consensus of the human population for that exact dilemma rather than by fixed, equal, or random weights.

In step 404, training engine 203 integrates the credence values into a reward function of RL agent 202 to guide its decision-making process.

As discussed above, in one embodiment, training engine 203 defines RL agent's overall ethical reward function as a credence-weighted sum of the choice-worthiness functions derived from the multiple ethical theories RL agent 202 considers (e.g., utilitarianism and deontology). For example, in one embodiment, the overall reward R(s,a,s′) that RL agent 202 seeks to maximize for taking action a in state s and transitioning to state s′ is constructed as a linear combination of the individual ethical theories' value functions, weighted by the human-preferred credence:

$$R ( s , a , {s}^{′} ) = {\sum }_{i} {C}_{i} {W}_{i} ( s , a , {s}^{′} )$$

where R(s,a,s′) is the total ethical reward received by RL agent 202 for a state transition. Furthermore, Cᵢ is the credence value derived from the Bradley-Terry model (and human preference data) for a specific ethical theory i (C_{Utilitarian}). These values ensure that ΣCᵢ=1. Additionally, Wᵢ(s,a,s′) is a choice-worthiness function (or intrinsic reward) for ethical theory i. This function is based on the hard-coded numerical severity weights (e.g., −1, −X) assigned to different actions under utilitarianism or deontology for that specific moral scenario.

By using this constructed reward function, training engine 203 guides RL agent 202 to prioritize actions that maximize the weighted sum of ethical outcomes. For example, if human preference for a scenario dictates C_{Utilitarian} is high (e.g., 0.8), then the reward of RL agent 202 will be heavily influenced by the utilitarian choice-worthiness W_{Utilitarian}. Conversely, if C_{Deontology} is high, then RL agent 202 will learn to favor actions that minimize direct harm, aligning with deontological rules.

This process ensures the agent's learned policy, which determines its “preferred ethical action,” directly aligns with the empirical human moral consensus quantified by the credence values rather than relying on a fixed or arbitrary 50/50 split between ethical theories.

In step 405, in connection with training engine 203 incorporating ethical theories and large language models (LLMs) in training RL agent 202, training engine 203 utilizes a large language model (LLM) to simulate complex moral reasoning based on the dataset by considering demographic distinctions in human preferences. By utilizing the LLM to simulate complex moral reasoning, AV systems are able to adapt to nuanced human factors, such as age and gender, in ethical decision-making.

As stated above, in one embodiment, the LLM simulation is guided by engineered prompts that direct the LLM to consider ethical theories (e.g., utilitarian, deontological) to enhance human-value alignment of ethical decisions.

In one embodiment, training engine 203 utilizes the LLM as a sophisticated reasoning engine that can process ethical frameworks and demographic variables simultaneously thereby allowing the system to model how human moral choices shift across different groups.

In one embodiment, training engine 203 implements the LLM for demographic-aware simulation using prompt engineering. Prompt engineering, as used herein, is a process of designing and refining instructions (prompts) for generative AI models to elicit desired and accurate outputs. In such an embodiment, the LLM is not simply asked to make a choice. Instead, it is guided to simulate the reasoning process.

For example, in the embodiment of using prompt engineering, training engine 203 constructs scenario prompts. For instance, training engine 203 takes a specific moral dilemma (e.g., “A crash is imminent; the choice is between hitting a 70-year-old man or a 10-year-old boy.”) from the dataset.

In another example, in the embodiment of using prompt engineering, training engine 203 injects ethical theories. For instance, training engine 203 utilizes prompts that are engineered to instruct the LLM to analyze the scenario by considering a plurality of ethical theories (e.g., justice, deontology, virtue ethics, commonsense morality, utilitarianism, etc.) thereby forcing the LLM to move beyond a single rule.

In a further example, in the embodiment of using prompt engineering, training engine 203 integrates demographic context. For instance, training engine 203 utilizes prompts that explicitly include the demographic distinctions (age, gender, etc.) of the victims/occupants and asks the LLM to justify its action based on these factors and the ethical theories.

In one embodiment, the LLM processes the engineered prompt to generate two critical outputs: action preference and detailed justifications. The action preference corresponds to the LLM's simulated choice (e.g., “save the boy,” reflecting a preference for youth). The detailed justification corresponds to the LLM providing a step-by-step, transparent explanation (Chain of Thought (CoT) reasoning) for its decision, referencing the ethical theories and demographic factors.

In one embodiment, the LLM's simulated results are then used to enhance the final moral policy of RL agent 202. For example, in one embodiment, the LLM's simulated results are used to enhance the final moral policy of RL agent 202 by modeling the demographic bias. In one embodiment, the LLM's output provides data on how moral decisions vary by age and gender, allowing the system to identify and model these demographic-based decision biases. For example, if the LLM consistently favors younger individuals, this pattern can be quantified.

In another example, the LLM's simulated results enhance the final moral policy of RL agent 202 by enhancing alignment and transparency. By analyzing the LLM's justifications, training engine 203 ensures that the final decisions align with human moral intuitions (the goal of the original dataset) and provides a mechanism for transparent explanation and accountability that traditional RL methods lack.

In essence, the LLM acts as an ethical interpreter, translating the static human preference data into a dynamic model capable of generalized, demographically-aware ethical reasoning that the final AV control system can leverage.

In step 406, training engine 203 guides a voting mechanism by the credence values (human-preferred credence values derived from the dataset) to influence decision-making of RL agent 202.

As discussed above, in one embodiment, training engine 203 uses the human-derived credence values (Cᵢ) as weights to influence the outcome of the ethical voting mechanism (e.g., Nash voting or variance voting), which resolves the “moral uncertainty” inherent in the dilemma.

In one embodiment, training engine 203 implements one or more weighted voting mechanisms, such as Nash voting or variance voting. In one embodiment, the Nash voting mechanism views ethical theories (e.g., utilitarianism, deontology) as competing agents that cast votes for or against available actions. The agents have a budget, and the cost of voting is proportional to the size of their vote. The variance voting mechanism, on the other hand, is a mechanism that prioritizes actions with lower variance in their expected outcomes across different ethical theories thereby choosing actions with a more cooperative or balanced risk profile.

In one embodiment, training engine 203 links the human-preferred credence values (Cᵢ) to the voting process thereby ensuring the final decision reflects human consensus. For example, with the Nash voting mechanism, the total voting budget or the influence of the votes caste by each ethical theory is scaled proportionally to its credence value (Cᵢ). A theory with a higher Cᵢ (reflecting stronger human preference) has a greater effective influence on the outcome of the vote thereby effectively embodying the principle of proportional say. The principle of proportional say dictates that when an agent, such as RL agent 202, is balancing different, often conflicting, ethical theories (e.g., utilitarianism and deontology), the influence of each theory on the final decision should be adjusted proportionally to its credence (Cᵢ), or the degree of belief assigned to it.

In another example, with the variance voting mechanism, the Q-values of each theory, which represents the preference of that theory, are normalized (variance-normalized) before voting. The Q-values of each theory (Q_{y}(s,a)) represent the expected, discounted cumulative choice-worthiness (or reward) for an ethical theory i, starting from states and taking action a, under a given policy π.

In one embodiment, Q_{y}(s,a) is a metric unique to each ethical theory i (e.g., utilitarianism, deontology). It quantifies the long-term goodness of an action strictly from that theory's perspective.

In one embodiment, the Q-value for theory i is:

$${Q}_{i} ( s , a ) = E [ {\sum }_{t = 0}^{∞} {γ}^{t} {W}_{i} ( {s}_{t} , {a}_{t} , {s}_{t + 1} ) \vert {s}_{0} = s , {a}_{0} = a ]$$

where Wᵢ is the choice-worthiness function (immediate reward) defined by theory i, and γ is the discount factor (how much future rewards are valued). In one embodiment, in the variance voting mechanism, these Q_{y}(s,a) values are considered the “preferences” of that theory for a given action. They are learned during the RL training process and are then used to calculate the variance and guide the final ethical decision.

In one embodiment, after the voting mechanism processes the preferences and weights, the mechanism outputs a final decision (e.g., “switch” or “do nothing”) that represents the ethically preferred action, considering both the intrinsic rewards of the ethical theories and the human-preferred credence weights. This resulting decision is the preferred ethical action that RL agent 202 determines and is subsequently executed to control autonomous vehicle 100.

Returning to FIG. 3, in conjunction with FIGS. 1-2 and 4, in step 303, controller 204 executes the preferred ethical action determined by the trained RL agent 202 to control autonomous vehicle (AV) 100.

As stated above, in one embodiment, controller 204 implements two phases, decision translation and vehicle control, to execute the preferred ethical action determined by the trained RL agent 202 to control AV 100.

In one embodiment, controller 204 receives the output from the decision-making system (trained RL agent 202, guided by human-preferred credence and voting mechanisms) in a high-level format. For example, the input corresponds to the final determination by RL agent 202, which is the preferred ethical action (e.g., “switch” or “do nothing”). Controller 204 then maps this abstract ethical command to specific, quantifiable vehicle maneuvers. For example, if the output is “switch,” then controller 204 translates this into commands for the vehicle's actuators, such as turn the steering wheel X degrees left and apply Y percent braking. In another example, if the output is “do nothing,” then controller 204 translates this into commands to maintain the current steering angle and maintain the current acceleration/deceleration profile.

In one embodiment, in the phase of vehicle control, controller 204 uses these translated commands to directly govern the AV's safety-critical systems in real-time. For example, controller 204 may send the signals to control module 120 of autonomous vehicle 100, which generates the appropriate commands, which are sent to vehicle control system 102 to control the AV's physical control systems (actuators) for steering (controlling the vehicle's lateral movement) and braking/acceleration (controlling the vehicle's longitudinal speed).

Furthermore, by performing such operations in real-time, the real-time execution ensures that the AV's physical behavior in the high-stakes dilemma is an on-the-road realization of the theoretical moral policy. This action determines the final outcome of the crash, aligning the vehicle's behavior with the ethical policy trained on societal moral standards.

In this manner, moral decision-making capabilities of autonomous vehicles are enhanced.

Furthermore, the principles of the present disclosure improve the technology or technical field involving autonomous vehicles

As discussed above, autonomous vehicles (AVs), also known as driverless or self-driving cars, are vehicles that can operate with little or no human input. They use sensors, cameras, and complex software to perceive their environment, make driving decisions, and perform actions, such as steering, accelerating, and braking. This technology can be applied to a wide range of vehicles, from cars and shuttles to trucks and buses. The rapid advancement of autonomous vehicles presents a critical challenge in ensuring their ethical decision-making capabilities, particularly in scenarios involving moral uncertainty and high stakes. Current approaches to AV decision-making primarily rely on established ethical frameworks, such as utilitarianism (maximizing overall well-being) or deontology (adherence to rules and duties). However, these rule-based systems often struggle with nuanced human ethical preferences and lack the adaptability to handle morally complex situations that may involve demographic-based decision biases (e.g., differences based on age or gender). This limitation poses a significant hurdle to societal acceptance and trustworthiness of AV technology as the public expects transparent and ethically aligned decision-making.

Embodiments of the present disclosure improve such technology by obtaining a dataset of human moral judgements regarding autonomous vehicle ethical dilemmas. In one embodiment, such a dataset is collected via a moral machine framework. The moral machine framework, as used herein, refers to a framework for collecting human moral judgements regarding ethical dilemmas. Furthermore, in one embodiment, a reinforcement learning (RL) agent is trained using the dataset to determine a preferred ethical action in a given dilemma. As a result of such training, the trained RL agent is responsible for synthesizing the human-preferred choices from the dataset (derived from the moral machine framework) into a functional policy. That is, the training process essentially translates complex human moral judgments—often expressed as conflicting utilitarian versus deontological outcomes—into a mathematically quantifiable action policy for the autonomous vehicle. The preferred ethical action in a given action that was determined by the trained RL agent is then executed to control the autonomous vehicle (AV). For example, the RL agent's ethically-informed decisions directly govern the AV's behavior, such as steering or braking. Such an execution of the preferred ethical action translates the theoretical moral policy trained on human preferences into an on-the-road control command that influences the vehicle's operation in real-time. In this manner, moral decision-making capabilities of autonomous vehicles are enhanced. Furthermore, in this manner, there is an improvement in the technical field involving autonomous vehicles.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for autonomous vehicle ethical decision-making, the method comprising:
obtaining a dataset of human moral judgements regarding autonomous vehicle ethical dilemmas, wherein said dataset is collected via a moral machine framework;
training a reinforcement learning agent using said dataset to determine a preferred ethical action in a given dilemma; and
executing said preferred ethical action determined by said trained reinforcement learning agent to control an autonomous vehicle.

2. The method as recited in claim 1 further comprising:
quantifying human preference within said dataset by integrating a Bradley-Terry (BT) model within said moral machine framework to perform pairwise comparisons on moral scenarios and generate strength parameters for potential actions.

3. The method as recited in claim 2 further comprising:
converting said generated strength parameters into credence values; and
integrating said credence values into a reward function of said reinforcement learning agent to guide its decision-making process.

4. The method as recited in claim 1 further comprising:
guiding a voting mechanism by human-preferred credence values derived from said dataset to influence decision-making of said reinforcement learning agent.

5. The method as cited in claim 1, wherein said training of said reinforcement learning agent comprises:
utilizing a large language model (LLM) to simulate complex moral reasoning based on said dataset by considering demographic distinctions in human preferences.

6. The method as recited in claim 5, wherein said LLM simulation is guided by engineered prompts that direct said LLM to consider a plurality of ethical theories to enhance human-value alignment of ethical decisions.

7. The method as recited in claim 1 further comprising:
quantifying an ethical outcome of potential actions under utilitarian and deontological theories by assigning numerical severity weights to different actions within specific moral scenarios.

8. A computer program product for autonomous vehicle ethical decision-making, the computer program product comprising one or more computer readable storage mediums having program code embodied therewith, the program code comprising programming instructions for:
obtaining a dataset of human moral judgements regarding autonomous vehicle ethical dilemmas, wherein said dataset is collected via a moral machine framework;
training a reinforcement learning agent using said dataset to determine a preferred ethical action in a given dilemma; and
executing said preferred ethical action determined by said trained reinforcement learning agent to control an autonomous vehicle.

9. The computer program product as recited in claim 8, wherein the program code further comprises the programming instructions for:
quantifying human preference within said dataset by integrating a Bradley-Terry (BT) model within said moral machine framework to perform pairwise comparisons on moral scenarios and generate strength parameters for potential actions.

10. The computer program product as recited in claim 9, wherein the program code further comprises the programming instructions for:
converting said generated strength parameters into credence values; and
integrating said credence values into a reward function of said reinforcement learning agent to guide its decision-making process.

11. The computer program product as recited in claim 8, wherein the program code further comprises the programming instructions for:
guiding a voting mechanism by human-preferred credence values derived from said dataset to influence decision-making of said reinforcement learning agent.

12. The computer program product as cited in claim 8, wherein said training of said reinforcement learning agent comprises:
utilizing a large language model (LLM) to simulate complex moral reasoning based on said dataset by considering demographic distinctions in human preferences.

13. The computer program product as recited in claim 12, wherein said LLM simulation is guided by engineered prompts that direct said LLM to consider a plurality of ethical theories to enhance human-value alignment of ethical decisions.

14. The computer program product as recited in claim 8, wherein the program code further comprises the programming instructions for:
quantifying an ethical outcome of potential actions under utilitarian and deontological theories by assigning numerical severity weights to different actions within specific moral scenarios.

15. A system, comprising:
a memory for storing a computer program for autonomous vehicle ethical decision-making; and
a processor connected to the memory, wherein the processor is configured to execute program instructions of the computer program comprising:
obtaining a dataset of human moral judgements regarding autonomous vehicle ethical dilemmas, wherein said dataset is collected via a moral machine framework;
training a reinforcement learning agent using said dataset to determine a preferred ethical action in a given dilemma; and
executing said preferred ethical action determined by said trained reinforcement learning agent to control an autonomous vehicle.

16. The system as recited in claim 15, wherein the program instructions of the computer program further comprise:
quantifying human preference within said dataset by integrating a Bradley-Terry (BT) model within said moral machine framework to perform pairwise comparisons on moral scenarios and generate strength parameters for potential actions.

17. The system as recited in claim 16, wherein the program instructions of the computer program further comprise:
converting said generated strength parameters into credence values; and
integrating said credence values into a reward function of said reinforcement learning agent to guide its decision-making process.

18. The system as recited in claim 15, wherein the program instructions of the computer program further comprise:
guiding a voting mechanism by human-preferred credence values derived from said dataset to influence decision-making of said reinforcement learning agent.

19. The system as cited in claim 15, wherein said training of said reinforcement learning agent comprises:
utilizing a large language model (LLM) to simulate complex moral reasoning based on said dataset by considering demographic distinctions in human preferences.

20. The system as recited in claim 19, wherein said LLM simulation is guided by engineered prompts that direct said LLM to consider a plurality of ethical theories to enhance human-value alignment of ethical decisions.
